(19) United States
(12) Patent Application Publication
(10) Pub. No.: US 2016/0080519 A1
(43) Pub. Date: Mar. 17, 2016

(54) LOCAL CACHING AND RESOLUTION OF SERVICE CALLS

(71) Applicant: Microsoft Technology Licensing, LLC, Redmond, WA (US)

(72) Inventors: Marc Hansen, Vedbeak (DK); Gert Willem Robyns, Hellerup (DK); Cristian Chereches, Copenhagen (DK); Thomas Hejlsberg, Horsholm (DK); Adam Millard, Frederiksberg (DK)

(21) Appl. No.: 14/588,596

(22) Filed: Jan. 2, 2015

Related U.S. Application Data
(60) Provisional application No. 62/049,067, filed on Sep. 11, 2014.

(51) Int. Cl. H04L 29/08

(52) U.S. Cl. CPC H04L 67/2852; H04L 67/16

(57) ABSTRACT

A local service system receives a call from a local application. The local service system determines whether an acceptable result to return for the call is already stored in a local service cache. If not, the local service system calls a remote service system to obtain a result, it returns the result to the local application, and stores the result in the local service cache.

### CROSS-REFERENCE TO RELATED APPLICATION

The present application is based on and claims the benefit of U.S. provisional patent application Ser. No. 62/049,067, filed Sep. 11, 2014, the content of which is hereby incorporated by reference in its entirety.

### BACKGROUND

Computer systems are currently in wide use. Some computer systems are deployed in an architecture in which a local computing system makes calls to a remote computing system that implements a service used by the local computing system.

In such cases, the remote computing system is often referred to as implementing software as a service (SaaS). Current SaaS implementations generally offer a relatively elegant way to separate software implementations that offer different services. However, SaaS implementations offer some challenges with regard to performance, testing, authentication, the cost of calls to the service, and other service-related metrics. In addition, where the local computing system is in a relatively remote location, it can encounter problems when attempting to remain online to call a remote service for information.

The discussion above is merely provided for general background information and is not intended to be used as an aid in determining the scope of the claimed subject matter.

### SUMMARY

A local service system receives a call from a local application. The local service system determines whether an acceptable result to return for the call is already stored in a local service cache. If not, the local service system calls a remote service system to obtain a result, it returns the result to the local application, and stores the result in the local service cache.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a service architecture.

FIG. 1A is a flow diagram illustrating one example of the operation of the architecture shown in FIG. 1.

FIG. 2 is a block diagram showing one example of the service architecture of FIG. 1, in more detail.

FIGS. 3A and 3B (collectively FIG. 3) show a flow diagram illustrating one example of the operation of the architecture shown in FIG. 2.

FIG. 4 is a flow diagram illustrating one example of the operation of the architecture shown in FIG. 2 in performing cache refresh operations for offline operation or for pre-population of the cache.

FIG. 5 is a flow diagram illustrating one example of the operation of the architecture shown in FIG. 2 in a testing environment.

FIG. 6 is a block diagram showing one example of the architecture illustrated in FIG. 1, in a cloud computing architecture.

FIGS. 7-9 show various examples of mobile devices that can be used in the architecture shown in FIGS. 1, 2 and 6.

FIG. 10 is a block diagram showing one example of a computing environment that can be used in any of the architectures described above.

### DETAILED DESCRIPTION

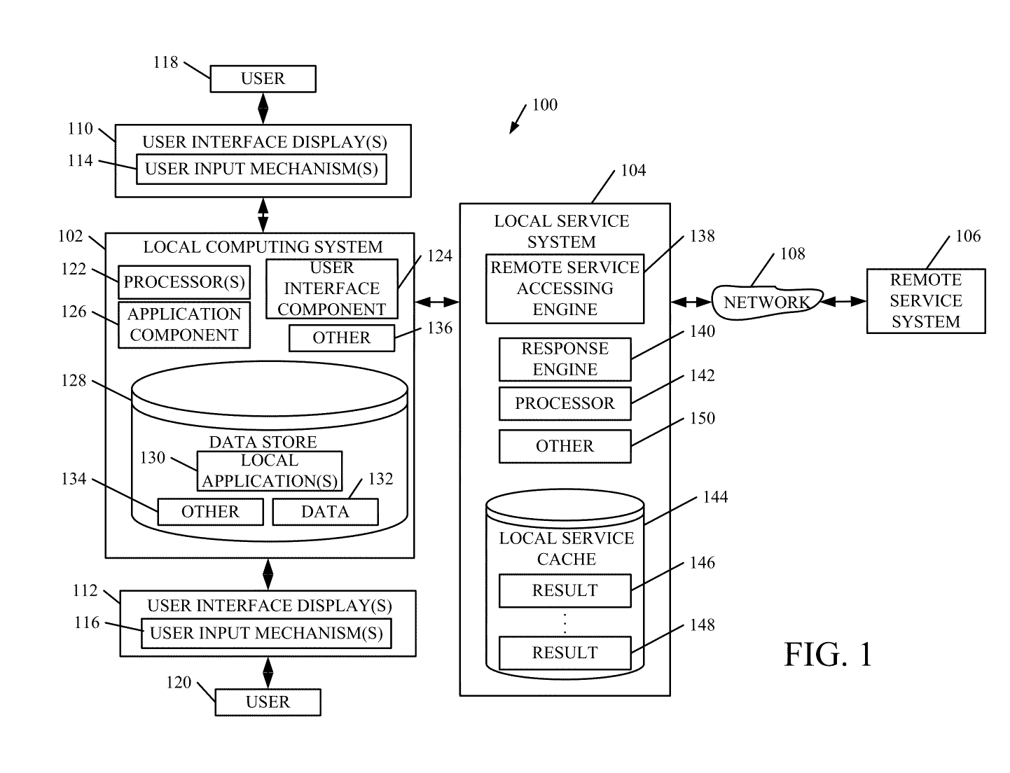

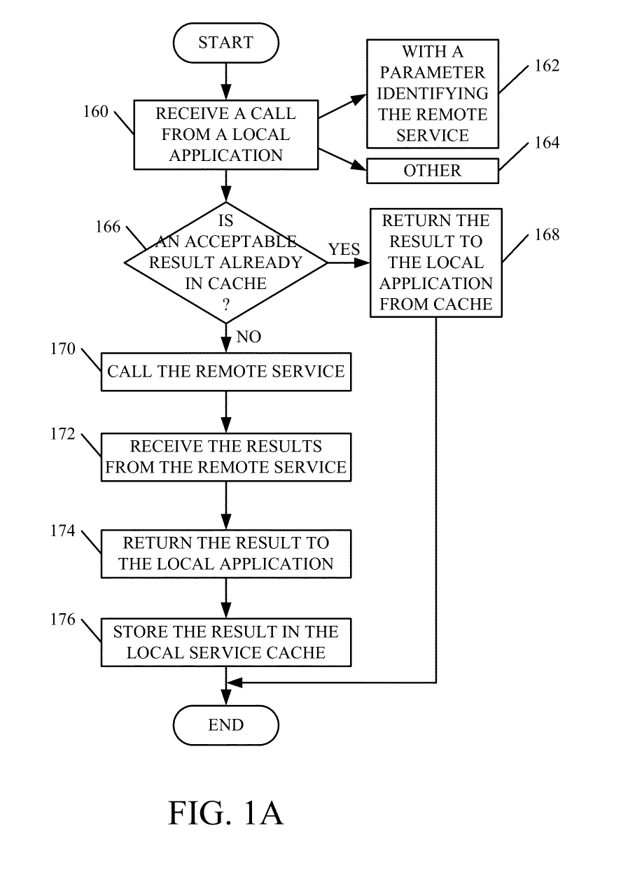

FIG. 1 is a block diagram of one example of a service architecture 100. Service architecture 100 includes local computing system 102, local service system 104, and remote service system 106. In the example shown in FIG. 1, local service system 104 is local to system 102 (in that it is not connected to it through a wide area network but instead is part of system 102 or is connected by a local area network, a near field communication system, or the like). Local service system 104 acts as a proxy for remote service system 106, and accesses information, when needed, from remote service system 106, over network 108. It will be noted that local computing system 102 and local service system 104 can all be part of the same computing system. However, they can be separate systems as well.

FIG. 1 shows that, in one example, local computing system 102 illustratively generates user interface displays 110 and 112, with user input mechanisms 114-116 for interaction by users 118-120. In one example, each of the users 118-120 can have a separate user device with which they access local computing system 102. It will also be noted that local computing system 102 can be deployed on a personal computing device (e.g., a desktop computer, a laptop computer, a mobile device, etc.) of a single user. However, the present discussion will proceed with respect to an example in which local computing system 102 is accessed by multiple different users 118-120, either directly, or using their own separate computing devices. It can be a multi-user computing system, a multi-tenant computing system, etc.

FIG. 1 shows that, in one example, local computing system 102 can include processor 122, user interface component 124, application component 126, and data store 128 (which itself illustratively includes one or more local applications 130, data 132, and it can include other items 134 as well). Local computing system 102 can also include other items 136.

In one example, user 120 accesses local computing system 102 to have application component 126 run a local application 130. The local application 130 is illustratively configured to intermittently make calls to obtain information from a remote service. By way of example, it may be that local application 130 is an application that intermittently makes calls to a remote service to obtain some type of varying value that is intermittently updated. As an example, local application 130 may call a processing queue service to identify delay for a processing queue. In another example, it may call a service to obtain currency exchange rate information. In such examples, remote service system 106 is illustratively a processing queue analysis service or a currency exchange rate service which, upon receiving a call from an application, returns requested delay times or currency exchange rate information to the application.

In order to address some of the challenges involved in making calls to remote service system 106, over network 108, architecture 100 provides local service system 104. Local service system 104, itself, illustratively includes remote service accessing engine 138, response engine 140, processor 142, local service cache 144 (which, itself, illustratively includes a plurality of different sets of results 146-148 that were obtained from remote service system 106 for different calls from local service system 104), and local service system 104 can also include other items 150 as well.

Before describing the overall operation of architecture 100, a brief overview will first be provided. As briefly mentioned above, it is assumed for the present description that a local application 130 is running on local computing system 102 and intermittently needs information provided by remote service system 106. In that case, it provides a call to local service system 104, with a parameter that identifies remote service system 106, from which the information is desired. Response engine 140 determines whether an adequate response to the call is already stored as a result 146-148 in local service cache 144. If so, it returns the appropriate result to local application 130, from cache 144. If not, however, it uses remote service accessing engine 138 to make a call to remote service system 106 to obtain the desired result. Once it receives the result from remote service system 106, it sends that result to local application 130, and stores it in local service cache 144, for possibly serving subsequent calls.

FIG. 1A is a flow diagram illustrating one example of the operation of architecture 100 in servicing calls. Local service system 104 first receives a call from a local application 130. This is indicated by block 160 in FIG. 1A. In one example, the call can include a parameter identifying the particular remote service system 106 from which information is sought, in the call. This is indicated by block 162. The call can of course include other information as well, as indicated by block 164.

Response engine 140 then illustratively determines whether an acceptable result for the call is already stored in local service cache 144. This is indicated by block 166. In one example, each of the results 146-148 in local service cache 144 illustratively includes a timestamp indicative of the time at which it was received from remote service system 106 and placed in cache 144. Therefore, in determining whether an acceptable result is already stored in cache 144, response engine 140 can determine not only whether a similar call was made to remote service system 106 in the past, for which the result is stored in cache 144, but also whether that result is stale or has otherwise expired, based upon its timestamp. Response engine 140 can determine whether an acceptable result is in cache 144 in other ways as well (some of which are described below), and these are only mentioned by way of example.

If an acceptable result is stored in cache 144, response engine 140 generates a response to the call from local application 130, and returns that result to the local application, from local service cache 144. This is indicated by block 168 in FIG. 1A. Engine 140 can do this, for instance, by placing information in the result into a form or format that is expected by application 130.

If response engine 140 determines that an acceptable result is not saved in cache 144, then it invokes remote service accessing engine 138 to call remote service system 106 over network 108. This is indicated by block 170. It then receives the result from the remote service system 106, as indicated by block 172. Response engine 140 returns that result to local application 130. This is indicated by block 174. Response engine 140 then stores the result in local service cache 144, so that it can potentially be used in servicing subsequent similar calls from local application 130, or from other local applications. Storing the result in the local service cache 144 is indicated by block 176 in FIG. 1A.

It can thus be seen that architecture 100 provides significant technical advantages. Calling remote service system 106 over network 108 can be time consuming Therefore, when local service system 104 services a call from local service cache 144, this can be done more quickly than servicing the call from remote service 106. This can thus significantly improve application performance. Further, where multiple users 118-120 are using the local application 130, a given call might be repeated many times, in a relatively short time span. Thus, when many of those repeated calls are serviced from the local cache 144, this can save a relatively large amount of time which would otherwise be spent in accessing remote service system 106. This even further enhances the performance of the computing system. In some examples, additional technical advantages can be obtained as well. Some of these are described below.

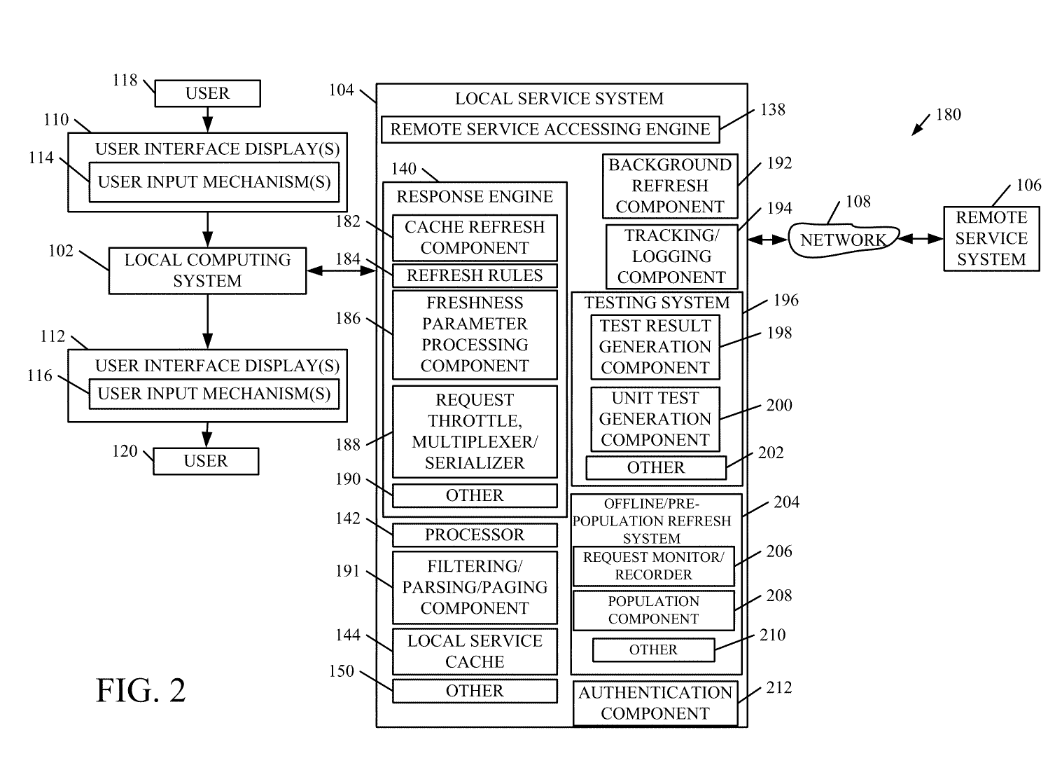

FIG. 2 is a block diagram of another service architecture 180. Some items of service architecture 180 are similar to those shown in architecture 100 of FIG. 1, and they are similarly numbered. However, architecture 180 illustrates an example of local service system 104, in more detail. For instance, FIG. 2 shows that, in one example, response engine 140 in local service system 104 can include a variety of additional components. It can include cache refresh component 182, refresh rules 184, freshness parameter processing component 186, request throttle, multiplexer and serializer 188, and it can include other items 190. FIG. 2 also illustrates an example in which local service system 104 can include background refresh component 192, tracking/logging component 194, testing system 196 (which, itself, can include test result generation component 198, unit test generation component 200, and it can include other items 202), offline/pre-population refresh system 204 (which, itself, can include request monitor/recorder 206, regulation component 208, and other items 210), and authentication component 212.

Before describing the overall operation of architecture 180 in more detail, a brief overview of a number of the items in architecture 180 will first be provided. Cache refresh component 182 can illustratively access refresh rules 184 to determine whether certain items in local service cache 144 need to be refreshed. For instance, refresh rules 184 may indicate a time limit (or time threshold value) after which a given result in cache 144 is to be considered stale or expired. In another example, the rules may be result dependent, application dependent, or dependent on other things. For instance, a service that returns currency exchange rates may return results that expire after a first time period. However, a service that returns a current computing load on a service, a network, etc., may return results that expire much more quickly. Thus, the refresh rules 184 illustratively indicate to cache refresh component 182 when an item in cache 144 is expired and is to be refreshed.

Freshness parameter processing component 186 illustratively processes freshness parameters that are received in the call from local application 130 (on local computing system 102). By way of example, it may be that the local application 130, itself, provides one or more parameters indicative of how fresh they would like the results to be. The parameters may include a first parameter, for instance, indicating that the local application requires the results to be obtained from remote service system 106, no matter how fresh they are in local cache 144. In another example, the local application 130 may provide a parameter, in its call, indicating that it would like the results to be at least as fresh as some indicated time period. The freshness parameters can be provided in other ways as well. Regardless of how they are provided, freshness parameter processing component 186 processes the freshness parameters and provides them to cache refresh component 182 so that cache refresh component 182 can determine whether the results in local service cache 144 are acceptable. For instance, component 182 can compare the freshness parameters received from component 186 to the time stamp on matching results in cache 144 to determine whether those results are to be refreshed from service 106.

Request throttle, multiplexer, serializer component 188 performs throttling, multiplexing and serializing operations on the calls. For instance, it may be that the organization that deploys local computing system 102 has a limit on the number of concurrent calls that can be made to remote service system 106. In another example, the organization may have a limit on a call rate (e.g., a number of calls that can be made to service 106 within a given time period). In that case, request throttle, multiplexer, serializer component 188 determines whether the number of concurrent calls or the request rate (indicative of the rate of requests being made on remote service system 106 over time) needs to be throttled back or serialized to stay within the limits. It can do this, for instance, by detecting calls to service 106 and computing a number of concurrent calls or the call rate over a rolling time window, and comparing the value to the limit. If the limits are reached, component 188 can place the calls in series so that the number of concurrent calls or the call rate to remote service system 106 does not exceed the limits. In an example where the call rate is limited, component 188 can place the call in a queue and defer the call for a time period to keep the call rate within limits. In another example, where the local computing system 102 is limited to a threshold number of concurrent calls that can be made to remote service system 106, component 188 can arrange the calls so that only the threshold number of concurrent calls are being made against remote service system 106 at a given time. The other calls are placed in series so that they are made, in turn, but the number of concurrent calls to remote service system 106 does not exceed the threshold value.

Filter/parsing/paging component 191 illustratively performs desired filtering, parsing and paging on the results that are returned by remote service system 106. By way of example, it may be that it is less expensive or otherwise more efficient to have remote service system 106 return a large data set, that includes information that is not specifically being requested by a local application 130. In that case, engine 138 can obtain the large data set from service 106, and component 191 filters the large data set or parses it to obtain a subset that is responsive to a given call. It can also arrange the returned results in pages, as desired by the local application 130.

Background refresh component 192 is illustratively a component that runs in the background, and intermittently determines whether the computing load on system 104 is decreased to a sufficient point that a background refresh operation can run. It can then preemptively, and in the background (e.g., without receiving an actual request), retrieve a set of fresh results from remote service system 106 and store it in cache 144. This increases the likelihood that future requests can be handled from cache 144, instead of using round trips to remote service system 106. The particular result sets that are refreshed can be determined in a variety of ways, some of which are described below.

Tracking/logging component 194 can be used to log the various entities and operations that are performed on system 104. For instance, it can log the particular users or local applications that are making calls, it can include metadata describing when the calls were made, how long they took to service, or a variety of other information.

Offline/pre-population refresh system 204 can illustratively use request monitor/recorder 206 to monitor and record the calls that are being made by the various local applications 130 and users 118-120, to service 106. Population component 208 can use the recorded information to identify particular results that should be refreshed in local service cache 144 for a variety of different operational reasons. For instance, if local service system 104 is about to begin operating offline (such as on a weekend or otherwise when online service is curtailed or eliminated), component 208 can illustratively replay all the calls that were made against the remote service system 106, or local service system 104, or both, during a predefined period in the past, and obtain refreshed results from remote service system 106 for all of those calls. This will improve the likelihood that calls that are made against local service system 104, when it is operating offline, will have relatively fresh results stored in cache 144.

In another example, components 206 and 208 can perform the same types of operations in anticipation of an increased user load on local service system 104. For instance, just before business hours begin on Monday morning, components 206 and 208 can illustratively operate to refresh all of the identified results in local service cache 144. That way, when users 118-120 begin to perform their business operations, it is more likely that the calls to local service system 104 can be serviced from local service cache 144, instead of making round trips to remote service system 106.

Testing system 196 illustratively provides a test environment in which a developer (which, for the present discussion, is user 120) can test code in local applications 130 by having local service system 104 return pre-constructed results which are stored in local service cache 144, or actual results which are stored in local service cache 144, without actually having to make a round trip to remote service system 106, in order to test the local application. Test result generation component 198 illustratively provides user interface displays that allow user 120 to provide either pre-constructed service results and store them in cache 144, or to identify a set of already-saved results in cache 144 that are to be used as test results and returned to the local application 130 during testing. Unit test generation component 200 illustratively allows user 120 to test new code or units of the application 130, during the build stage, instead of only after the build is complete. User 120 can thus test the application 130 under development to see whether it adequately processes the test results that are returned from local service system 104. This can all be done without accessing remote service system 106.

Authentication component 212 illustratively uses authentication information to authenticate itself with remote service system 106. For instance, it can provide a username and password to system 106 in response to an authentication prompt or otherwise. By doing this, the authentication information that is needed to authenticate the system to remote service system 106 need not be propagated to all of the different users 118-120, or even to all of the local computing systems 102. Instead, those systems can perform their own authentication with users 118-120, but the authentication with remote service system 106 can remain hidden, because it is provided by authentication component 212 in local service system 104.

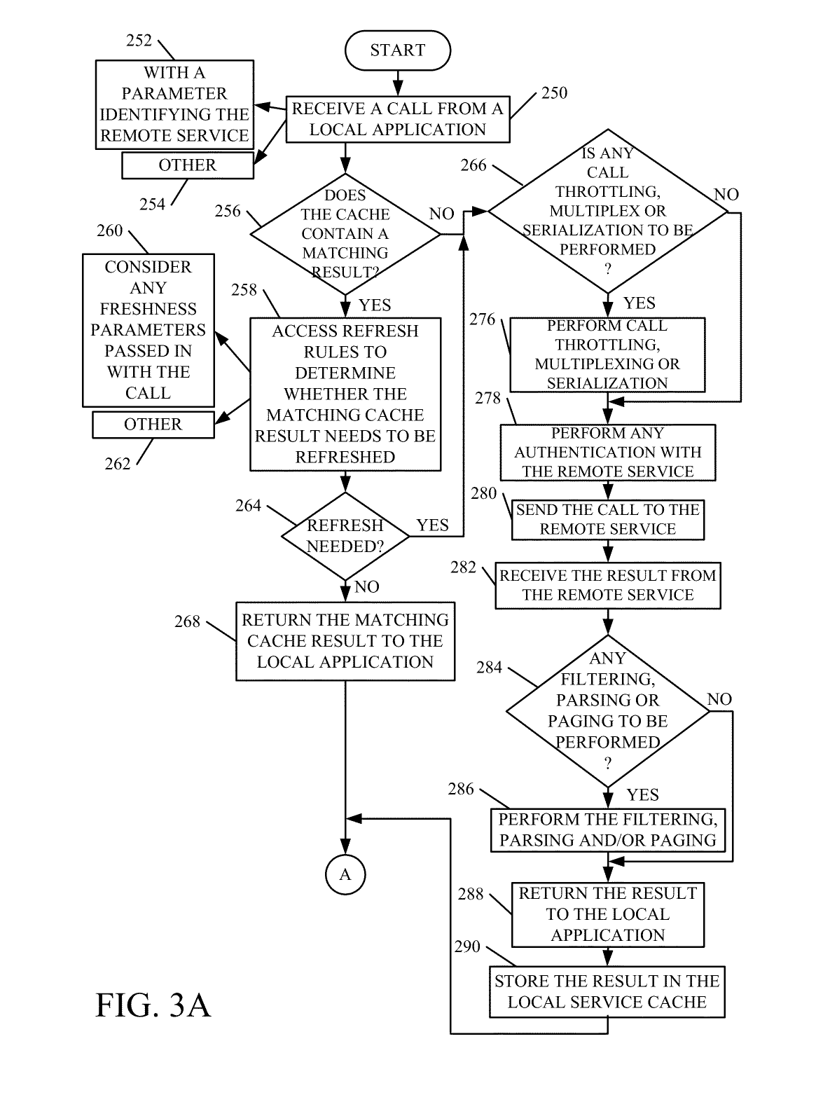

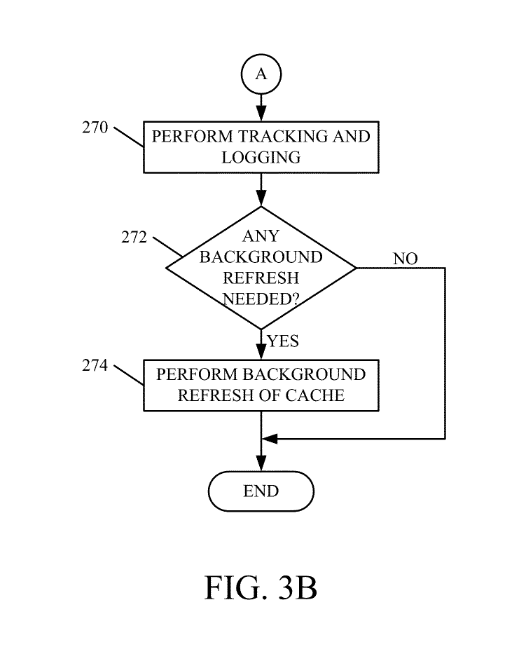

FIGS. 3A and 3B (collectively FIG. 3) show a flow diagram illustrating one example of the architecture 180 in servicing calls from a local application 130 in local computing system 102. Response engine 140 first receives a call from a local application. This is indicated by block 250 in FIG. 3. Again, it can include a parameter that identifies the particular remote service system 106 from which the result is desired. This is indicated by block 252. It can include other parameters as well, as indicated by block 254.

Response engine 140 then examines local service cache 144 to determine whether it contains a result that matches the call. This is indicated by block 256 in FIG. 3. For instance, each result in cache 144 can be indexed by the particular call made to obtain it. Engine 140 can determine whether any results in cache 144 were in response to the same call as was just received. If so, cache refresh component 182 accesses refresh rules 184 to determine whether the matching cache result needs to be refreshed, or whether it can simply be provided in response to the present call. This is indicated by block 258. Again, cache refresh component 182 can access not only the refresh rules 184, but it can also consider any freshness parameters passed in with the call from the local application (and as analyzed by component 186), or it can identify whether the result needs to be refreshed in other ways as well. This is indicated by blocks 260 and 262 in FIG. 3.

Based upon the refresh rules, and possibly the parameters passed in with the call, cache refresh component 182 determines whether the matching result needs to be refreshed. This is indicated by block 264. If so, processing reverts to block 266 which is described in greater detail below. If not, however, then response engine 140 simply returns the matching cache result from local service cache 144 to the local application 130. This is indicated by block 268 in FIG. 3.

Tracking/logging component 194 can then illustratively perform tracking and logging operations which obtain and log the particular information that is to be logged regarding the call. This is indicated by block 270 in FIG. 3. This can include a wide variety of different types of information, some of which were described above.

At any time during the processing described in FIG. 3A, background refresh component 192 can determine whether any background refresh operations need to be performed. This is indicated by block 272. For instance, if the processing load on local system 104 is relatively low, and the results in cache 144 are relatively old, component 192 may perform refresh operations by requesting results from remote service system 106 and refreshing their corresponding values in local service cache 144. Component 192 can preferentially refresh certain results first. For instance, it can maintain a list of most frequently made calls and refresh those results first. It can maintain a list of which calls exert the greatest load on remote service system 106 and preferentially refresh results based on that information, etc. Performing the background refresh operations for the cache 144 is indicated by block 274.

Referring again to block 256 in FIG. 3 where response engine 140 determines whether the local service cache 144 contains a matching result (that matches the call from local application 130), if the answer is no, or if at block 264 it is determined that the matching result needs to be refreshed, then processing continues at block 266. At block 266, request throttle, multiplexer, serializer component 188 determines whether any call throttling, multiplexing or serialization is to be performed. For instance, as discussed above, if there are currently a maximum number of concurrent calls being made to remote service system 106, then component 188 illustratively places the present call in series, behind those calls. If the call rate against remote service system 106 is at its threshold level, then component 188 illustratively introduces a delay in submitting the present call against remote service system 106. Other throttling, multiplexing or serialization can be performed as well. Performing these types of operations is indicated by block 276 in FIG. 3.

When it is determined that it is an appropriate time to make the call to remote service system 106, remote service accessing engine 138 illustratively uses authentication component 212 to perform any authentication of system 104 to remote service system 106. This is indicated by block 278 in FIG. 3. It then sends the call to the remote service system 106. This is indicated by block 280.

Remote service system 106 returns results for the call over network 108 to remote service accessing engine 138. Receiving the results from the remote service system 106 is indicated by block 282.

Filter/parsing/paging component 191 then determines whether any filtering, parsing or paging is needed for the returned results. As is discussed above, it may be that a larger set of results is returned, than is actually requested by the particular call. In that case, the results can be parsed and filtered before they are provided back to the local application 130. By way of example, when local application 130 is asking for a set of all zip codes in the state of Minnesota, it may be cheaper or quicker or more efficient to obtain a full set of zip codes for the entire United States of America from remote service system 106. If that is the case, then remote service accessing engine 138 obtains those results and provides them to component 191, which parses the results into zip codes for individual states, and returns only those results for the state of Minnesota, as requested by the call. It can also break the results into pages, as desired. For instance, it may return the results in pages of 25 entries per page, etc. Of course, this is only one example and a wide variety of other examples can be used as well.

Determining whether any filtering, parsing or paging operations are to be performed, and performing those operations, is indicated by blocks 284 and 286 in FIG. 3.

When the results are in proper form, they are returned by response engine 140 to the calling local application 130. This is indicated by block 288 in FIG. 3. The results are also illustratively stored by response engine 140, in local service cache 144. This is indicated by block 290. Processing then continues at blocks 270-274, as described above.

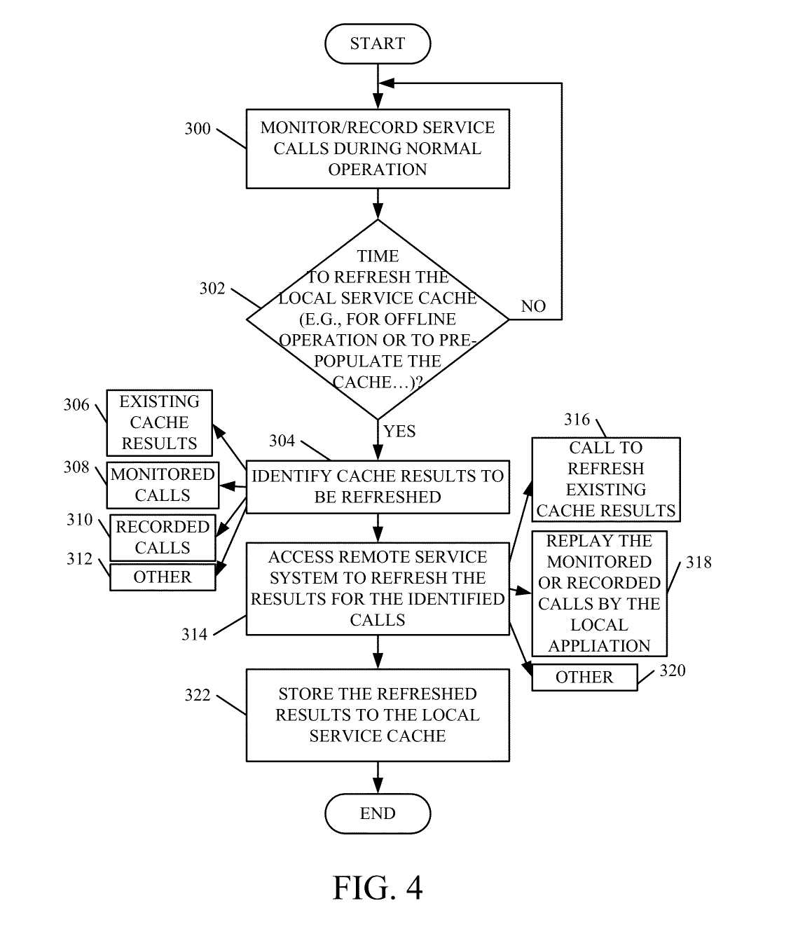

FIG. 4 is a flow diagram illustrating one example of the operation of architecture 100 in performing offline or pre-population refresh operations using system 204. In one example, request monitor/recorder 206 first monitors and records the different service calls during normal operation of local service system 104. This can include the various calls made by local applications 130 to local service system 104. Monitoring and recording the service calls is indicated by block 300 in FIG. 4.

Population component 208 illustratively uses the recorded information to intermittently repopulate local service cache 144 with refreshed results of the recorded calls. This is indicated by block 302. This can be done in a wide variety of different ways. For instance, if component 208 determines that local service system 104 is about to go offline, it may repopulate cache 144 with the call results so that it can locally service calls with relatively fresh information. In another example, if component 208 determines that the call volume against remote service system 106 is about to increase, it can replay all of the recorded calls against system 106 to again prepopulate cache 144 with relatively fresh information. Therefore, for instance, early Monday morning before work hours begin, component 208 can prepopulate cache 144 with all of the results for relatively popular calls so that those calls can be serviced locally instead of making round trips to remote service system 106.

Once component 208 determines that it is time to refresh cache 144, it identifies the cache results to be refreshed. This is indicated by block 304. It can identify those results as all existing cache results 306, those monitored during a predetermined period of operation, as indicated by block 308, all recorded calls (or the most frequently made calls) for a predetermined time period, as indicated by block 310, the calls that are most costly in terms of processing overhead on system 106 (e.g., those that take the most time to service), or in other ways as indicated by block 312.

Component 208 then uses remote service accessing engine 138 to access remote service system 106 to refresh the results for the identified calls. This is indicated by block 314. For instance, it can call system 106 to refresh the existing cache results in cache 144. This is indicated by block 316. It can replay the monitored or recorded calls received from local applications 130. This is indicated by block 318. It can access the remote service system 106 in other ways as well, and this is indicated by block 320.

Population component 208 then stores the refreshed results to the local service cache 144. This is indicated by block 322.

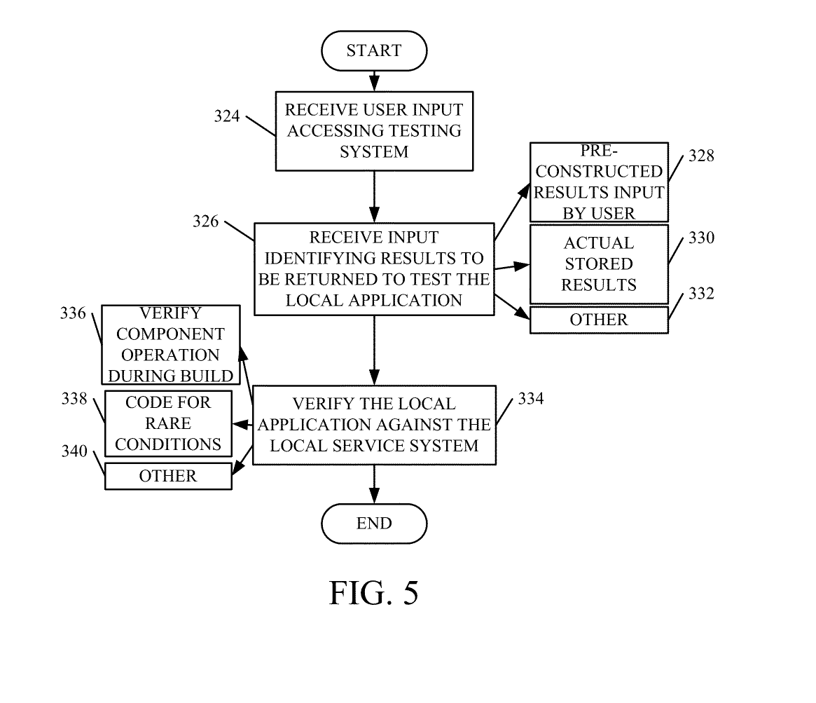

FIG. 5 is a flow diagram illustrating one example of architecture 100 in allowing a developer (e.g., user 120) to test or verify new code for local application 130 against local service system 104, without accessing remote service system 106. Testing system 196 first receives a user input from user 120 indicating that the user wishes to access the testing system 196. This is indicated by block 324 in FIG. 5.

Test result generation component 198 then generates user interface displays, with user input mechanisms, that allow user 120 to identify the test results that are to be used in the test. Receiving the input identifying results to be returned to test the local application is indicated by block 326. These can be pre-constructed results that are loaded into cache 144, by user 120. This is indicated by block 328. They can also (or in the alternative) be actual stored results that are identified in cache 144. This is indicated by block 330. The results can be identified in other ways as well, as indicated by block 332.

Unit test generation component 200 then generates user interface displays with user input mechanisms that allow user 120 to initiate testing of the local application under development, against the local service system 104. User 120 can then verify that the local application 130 is operating correctly. This is indicated by block 334. For instance, user 120 can verify component operation during the build phase, as indicated by block 336. User 120 can also verify code for relatively rare conditions as indicated by block 338.

An example may be helpful. It may be that the code being developed by user 120 is code that is developed to handle relatively rare conditions. Therefore, unless the user 120 is provided with the ability to test that code using pre-configured test results, it may be difficult to test the code, because the conditions rarely occur. To further illustrate this, by example, assume again that the local application 130 that is being developed is an application that is to take certain actions when a given processing load drastically increases in a short period of time. User 120 can pre-construct results that are returned in response to a call by local application 130, that indicate these conditions. Thus, by running the application under development against local service system 104, the call will return the results that reflect the relatively rare condition, so that user 120 can verify the operation of the application 130 under development, when those conditions arise.

The testing system 196 can include functionality that allows user 120 to verify the local application against the local service system 104 in other ways as well. This is indicated by block 340.

It can thus be seen that the various architectures described herein provide significant technical advantages and technical solutions to technical problems. They improve the performance of not only the local computing system 102, but the local service system 104. They improve the design and testing experience, and they improve the user experience as well. For instance, the first time a local application 130 calls the remote service system 106, that result can be returned from remote service system 106 and stored in cache 144. Subsequent calls from local application 130, for the same set of data, can then be serviced from local cache 144. This can drastically increase performance and lower the cost of using service 106. The cost savings is further increased in architectures that are both multi-user and multi-tenant, because a given call can be repeated many times in a relatively short duration. All or most of these repeated calls may be serviced locally.

The system can also preemptively, in the background, retrieve fresh cache results and store them in cache 144, so many requests can be handled from cache 144. The refresh rules 184 can also indicate different times for refreshing the cache, depending upon load and/or importance of the data requested. For instance, during weekends or holidays, there may be less of a need to refresh the cache 144. The same is true for less critical information. The system can also prepare the cache for an anticipated increase in workloads, or for anticipated offline operation. It can record the list of service requests and replay those service requests against system 106 to refresh the cache 144 for offline operation, or to prepopulate the cache at the beginning of an anticipated increase in workload (such as at the beginning of a work day).

It can allow a developer to test and verify code that is even designed to perform processing steps under rare conditions. The test results can be pre-constructed and loaded into the cache 144. It can also store actual results from remote service system 106, that can be used to test components of a local application 130. This can provide consistency for testing, which is relatively difficult to achieve in real world operation or deployments. It also allows the developer to verify the operation during the build phase instead of waiting until post-build. This can result in higher quality code, a reduced number of bugs given that defects can be identified and addressed at compile time, and all this testing can be performed without accessing remote service system 106, which lowers the cost of testing.

In addition, where remote service system 106 requires authentication, the authentication component 212 can conduct the authentication, without distributing the needed credentials to all users and/or applications. Because the authentication call is handled by authentication component 212, the credentials can be kept hidden from the users and applications 130.

The architecture can further improve cost performance by performing filtering, parsing and paging operations. If a given call requests only a subset of a larger data set, the architecture can retrieve the larger data set from remote service system 106 and store it in cache 144. It can be filtered, parsed, and paged so that the given call only receives the requested results. This reduces the number of round trips to remote service system 106, and can thus reduce the cost of using system 106.

The local service system 104, or portions of it, can be deployed locally on a given user's desktop computer, laptop computer, mobile device, etc. In addition, or in the alternative, it can be deployed in a local network that offers shared caching for all users on the local network. The latter architecture offers even more performance enhancements because a given user can now obtain cached results that were retrieved by a previous call made by a different user. Also, where access to remote service system 106 is restricted based on the number of requests, the rate of requests over time, the number of concurrent requests, or in other ways, local service system 104 can monitor, throttle, multiplex and serialize the calls received from local applications 130, based upon a predefined set of rules, or dynamically. This can create cost savings and it can also ensure that the requests do not exceed the threshold levels.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

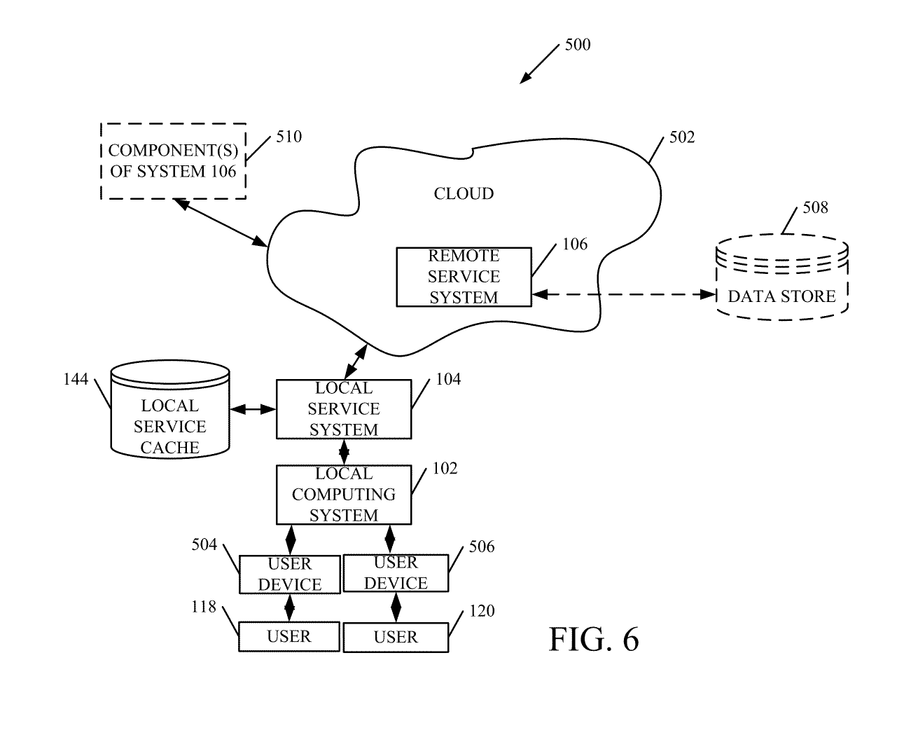

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that remote service system 106 can be located in cloud 502 (which can be public, private, or a combination where portions are public while others are private). Therefore, users 118-120 can use user devices 504-506 to access those systems through cloud 502.

FIG. 6 also depicts another example of a cloud architecture. FIG. 6 shows that it is also contemplated that some elements of remote service system 106 can be disposed in cloud 502 while others are not. By way of example, the system data stores 508 can be disposed outside of cloud 502, and accessed through cloud 502. In another example, components 510 of system 106 can also be outside of cloud 502. Regardless of where they are located, they can be accessed directly by devices 504-506, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

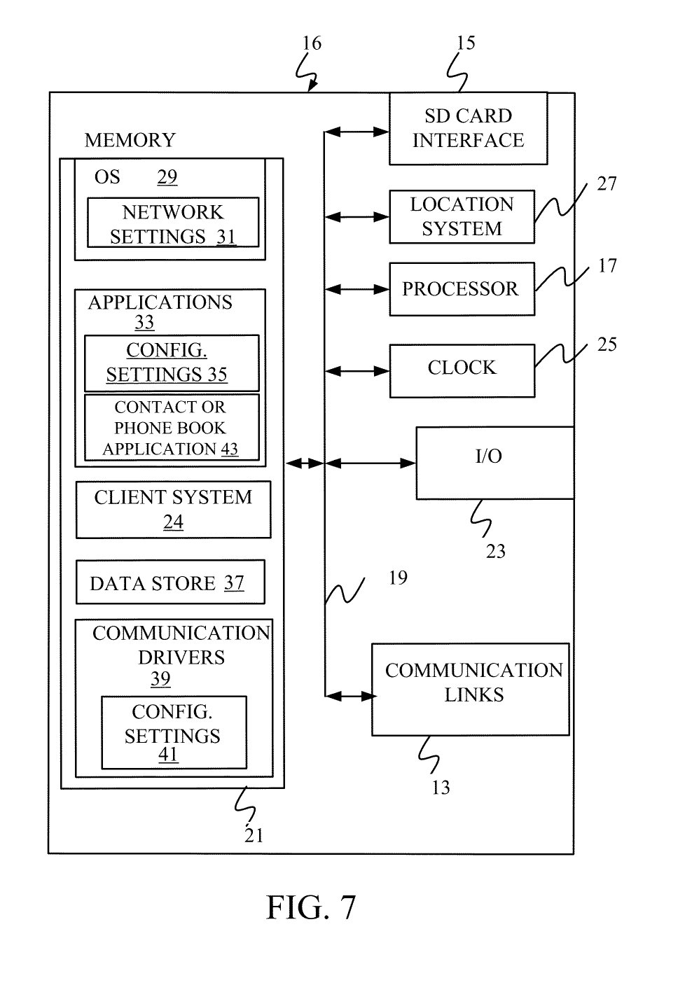

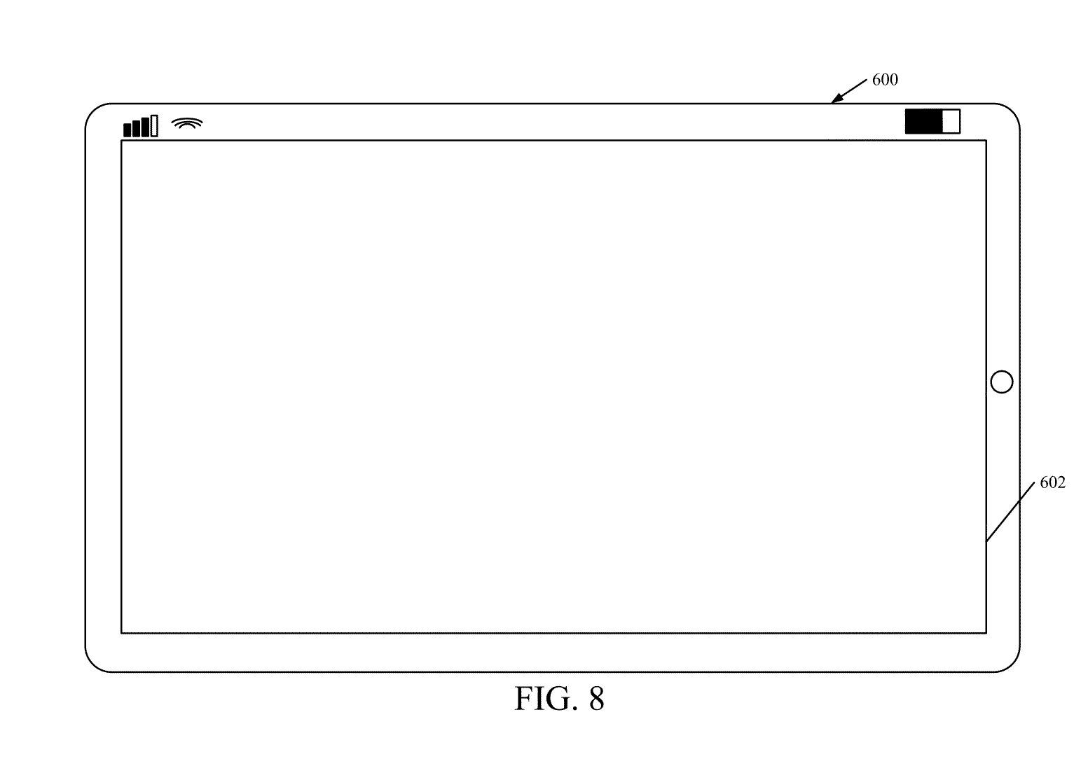

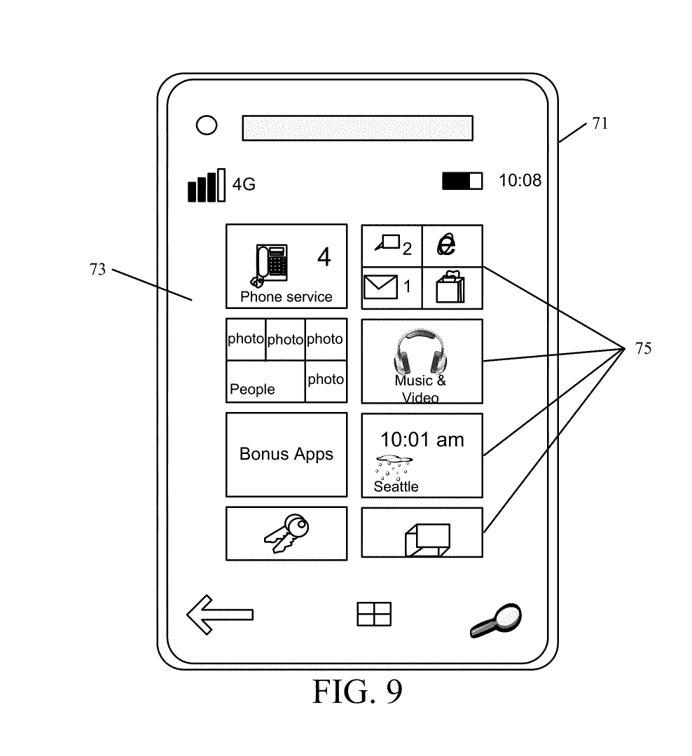

FIG. 7 is a simplified block diagram of one illustrative example of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components of system 102 or system 104 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 122 or 142 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 156, for example, can reside in memory 21. Similarly, device 16 can have a client system 24 which can run various business applications or embody parts or all of tenant 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one example in which device 16 is a tablet computer 600. In FIG. 8, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of device 16 can also be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples, the phone also includes a Secure Digital (SD) card slot that accepts a SD card.

The mobile device can also be a personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. Although not shown, the PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 9 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

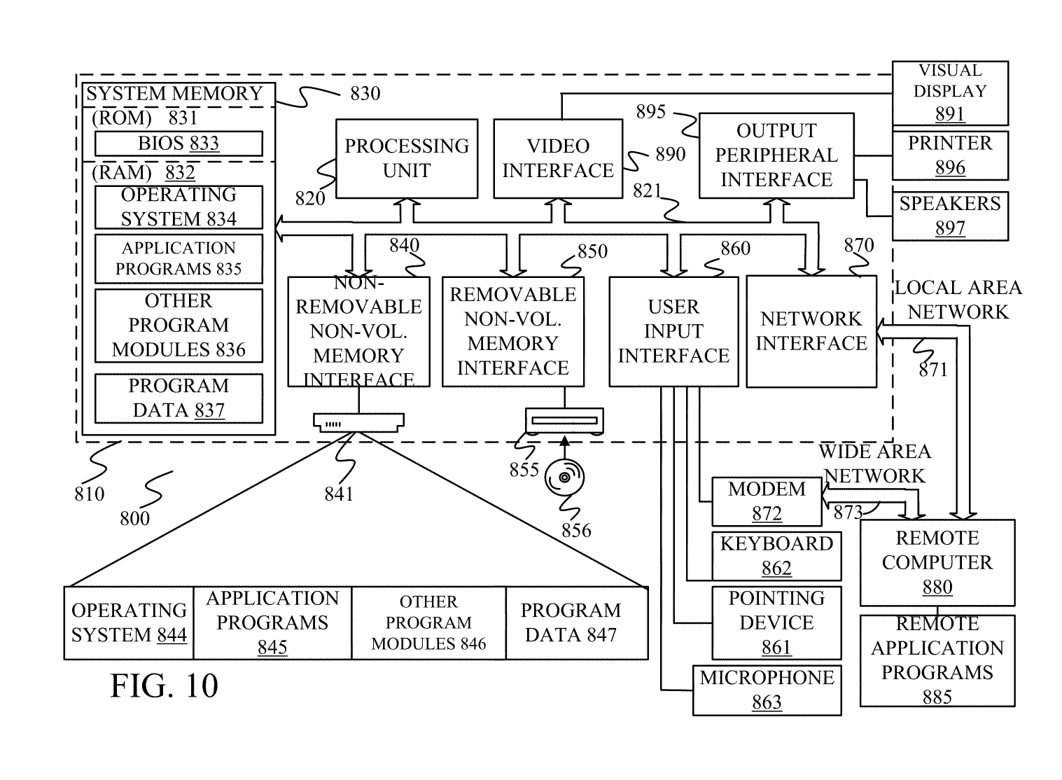

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 122 or 142 or those in devices 504-506), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a local service computing system that is local to a multi-user computing system and that responds to service calls from users of the multi-user computing system, comprising:

a local service cache that stores results from calls by the multi-user computing system to a remote service system;

a response engine that receives an incoming service call from the multi-user computing system to a remote service system and accesses the local service cache to determine whether the local service cache has an acceptable result that is responsive to the incoming service call and, if so, retrieves the acceptable result and responds to the incoming service call with the acceptable result; and

a remote service accessing engine that passes the incoming service call to the remote service system to receive a fresh result, in response to the response engine determining that the local service cache does not have an adequate result, the response engine responding to the incoming service call with the fresh result.

Example 2 is the local service computing system of any or all previous examples wherein the response engine determines whether the local service cache has an acceptable result by determining whether the local service cache has a responsive result that is responsive to the incoming service call and further comprises:

a cache refresh component that accesses a set of refresh rules and determines, based on the refresh rules and a freshness indicator on the responsive result, whether the responsive result is sufficiently fresh or needs to be refreshed from the remote service system.

Example 3 is the local service computing system of any or all previous examples wherein the incoming service call includes a freshness parameter and wherein the response engine further comprises:

a freshness parameter processing component that receives the freshness parameter and determines a corresponding freshness indicated by the freshness parameter, the cache refresh component determines whether the responsive result is sufficiently fresh based on the freshness determined by the freshness parameter processing component.

Example 4 is the local service computing system of any or all previous examples wherein the remote service accessing system calls the remote service system to receive over-inclusive results for a given incoming service call and receives the over-inclusive results from the remote service system, and further comprising:

a filtering component that parses the over-inclusive results to identify responsive results, the cache refresh component storing the over-inclusive results in the local service cache and identifying the responsive results as responsive to the given incoming service call in the local service cache.

Example 5 is the local service computing system of any or all previous examples and further comprising:

a request throttling component that determines when the multi-user computing system has reached a threshold call level to the remote service system and reduces the call level until the call level is within the threshold call level.

Example 6 is the local service computing system of any or all previous examples wherein the request throttling component reduces the call level by serializing service calls or multiplexing the service calls.

Example 7 is the local service computing system of any or all previous examples and further comprising:

a tracking component that logs characteristics of service calls made by the multi-user computing system for results from the remote service system; and

a refresh system that determines that a refresh operation is to be performed, identifies a set of results in the local service cache that are to be updated, based on the logged characteristics of the service calls, and refreshes the identified set of results with corresponding results from the remote service system.

Example 8 is the local service computing system of any or all previous examples wherein the refresh system refreshes the identified set of results by replaying service calls, that were used to obtain the identified set of results, against the remote service system.

Example 9 is the local service computing system of any or all previous examples wherein the refresh system identifies the set of results as those that are most frequently made by the multi-user computing system or those that take a greatest amount of processing overhead of the remote service system.

Example 10 is the local service computing system of any or all previous examples and further comprising:

a test result generation component that receives inputs indicative of test results to return to a calling application under test and that stores the test results in the local service cache, the response engine returning the test results when the application under test makes calls to the local service system; and

a test generation component that receives test inputs indicating that the application under test is to be tested and providing an output to the response engine indicating that, in response to calls from the application under test, the test results are to be returned.

Example 11 is the local service computing system of any or all previous examples and further comprising:

an authentication component that authenticates users of the multi-user computing system, the remote service accessing engine and the response engine responding to the authenticated users, without authentication of the users of the multi-user computing system to the remote service system.

Example 12 is a computer-implemented method, comprising:

receiving, at a local service system that is local to a multi-user computing system, a call from a calling system to a remote service system;

determining whether a matching result, that matches the call, is stored in a local service cache;

if so, accessing a set of refresh rules to determine whether the matching result is to be refreshed and, if the matching result is not to be refreshed, then returning the matching result to the calling system from the local service cache in response to the call; and

if the matching result is to be refreshed based on the refresh rules or if a matching result is not stored in the local service cache, then sending the call to the remote service system, receiving fresh results from the remote service system, and storing the fresh results in the local service cache.

Example 13 is the computer-implemented method of any or all previous examples and further comprising:

identifying characteristics of the call and storing the identified characteristics of the call.

Example 14 is the computer-implemented method of any or all previous examples and further comprising:

determining that a cache refresh is to be performed;

identifying cache results to be refreshed in the local service cache based on the stored characteristics of the call that requested the results; and

refreshing the identified cache results in the local service cache.

Example 15 is the computer-implemented method of any or all previous examples wherein identifying cache results to be refreshed comprises:

identifying all results in the local service cache as cache results to be refreshed.

Example 17 is the computer-implemented method of any or all previous examples wherein identifying cache results to be refreshed comprises:

identifying cache results responsive to a set of most frequent calls as the cache results to be refreshed.

Example 18 is the computer-implemented method of any or all previous examples wherein identifying cache results to be refreshed comprises:

identifying cache results as the cache results to be refreshed based on a computing overhead used by the remote service system in servicing corresponding calls for the cache results.

Example 19 is a computer readable storage medium that stores computer executable instructions which, when executed by a computer, cause the computer to perform a method, comprising:

receiving, at a local service system that is local to a multi-tenant computing system, a call from a calling system to a remote service system;

determining whether a matching result, that matches the call, is stored in a local service cache;

if so, accessing a set of refresh rules and a freshness parameter provided in the call to determine whether the matching result is to be refreshed and, if the matching result is not to be refreshed, then returning the matching result to the calling system from the local service cache in response to the call; and

if the matching result is to be refreshed based on the refresh rules or freshness parameter or if a matching result is not stored in the local service cache, then sending the call to the remote service system, receiving fresh results from the remote service system, and storing the fresh results in the local service cache.

Example 20 is the computer readable storage medium of any or all previous examples wherein the fresh result is over-inclusive of results responsive to the call, and further comprising:

parsing the fresh result to identify the results responsive to the call;

breaking the results responsive to the call into pages;

returning to the calling system the results responsive to the call; and

storing the results responsive to the call in the local service cache with a call indicator identifying the call the results are responsive to.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A local service computing system that is local to a multi-user computing system and that responds to service calls from users of the multi-user computing system, comprising:
a local service cache that stores results from calls by the multi-user computing system to a remote service system;
a response engine that receives an incoming service call from the multi-user computing system to a remote service system and accesses the local service cache to determine whether the local service cache has an acceptable result that is responsive to the incoming service call and, if so, retrieves the acceptable result and responds to the incoming service call with the acceptable result; and
a remote service accessing engine that passes the incoming service call to the remote service system to receive a fresh result, in response to the response engine determining that the local service cache does not have an adequate result, the response engine responding to the incoming service call with the fresh result.

2. The local service computing system of claim 1 wherein the response engine determines whether the local service cache has an acceptable result by determining whether the local service cache has a responsive result that is responsive to the incoming service call and further comprises:
a cache refresh component that accesses a set of refresh rules and determines, based on the refresh rules and a freshness indicator on the responsive result, whether the responsive result is sufficiently fresh or needs to be refreshed from the remote service system.

3. The local service computing system of claim 2 wherein the incoming service call includes a freshness parameter and wherein the response engine further comprises:
a freshness parameter processing component that receives the freshness parameter and determines a corresponding freshness indicated by the freshness parameter, the cache refresh component determines whether the responsive result is sufficiently fresh based on the freshness determined by the freshness parameter processing component.

4. The local service computing system of claim 2 wherein the remote service accessing system calls the remote service system to receive over-inclusive results for a given incoming service call and receives the over-inclusive results from the remote service system, and further comprising:
a filtering component that parses the over-inclusive results to identify responsive results, the cache refresh component storing the over-inclusive results in the local service cache and identifying the responsive results as responsive to the given incoming service call in the local service cache.

5. The local service computing system of claim 2 and further comprising:
a request throttling component that determines when the multi-user computing system has reached a threshold call level to the remote service system and reduces the call level until the call level is within the threshold call level.

6. The local service computing system of claim 5 wherein the request throttling component reduces the call level by serializing service calls or multiplexing the service calls.

7. The local service computing system of claim 2 and further comprising:
a tracking component that logs characteristics of service calls made by the multi-user computing system for results from the remote service system; and
a refresh system that determines that a refresh operation is to be performed, identifies a set of results in the local service cache that are to be updated, based on the logged characteristics of the service calls, and refreshes the identified set of results with corresponding results from the remote service system.

8. The local service computing system of claim 7 wherein the refresh system refreshes the identified set of results by replaying service calls, that were used to obtain the identified set of results, against the remote service system.

9. The local service computing system of claim 8 wherein the refresh system identifies the set of results as those that are most frequently made by the multi-user computing system or those that take a greatest amount of processing overhead of the remote service system.

10. The local service computing system of claim 2 and further comprising:
a test result generation component that receives inputs indicative of test results to return to a calling application under test and that stores the test results in the local service cache, the response engine returning the test results when the application under test makes calls to the local service system; and
a test generation component that receives test inputs indicating that the application under test is to be tested and providing an output to the response engine indicating that, in response to calls from the application under test, the test results are to be returned.

11. The local service computing system of claim 2 and further comprising:
an authentication component that authenticates users of the multi-user computing system, the remote service accessing engine and the response engine responding to the authenticated users, without authentication of the users of the multi-user computing system to the remote service system.

12. A computer-implemented method, comprising:
receiving, at a local service system that is local to a multi-user computing system, a call from a calling system to a remote service system;
determining whether a matching result, that matches the call, is stored in a local service cache;
if so, accessing a set of refresh rules to determine whether the matching result is to be refreshed and, if the matching result is not to be refreshed, then returning the matching result to the calling system from the local service cache in response to the call; and
if the matching result is to be refreshed based on the refresh rules or if a matching result is not stored in the local service cache, then sending the call to the remote service system, receiving fresh results from the remote service system, and storing the fresh results in the local service cache.

13. The computer-implemented method of claim 12 and further comprising:
identifying characteristics of the call and storing the identified characteristics of the call.

14. The computer-implemented method of claim 13 and further comprising:
determining that a cache refresh is to be performed;
identifying cache results to be refreshed in the local service cache based on the stored characteristics of the call that requested the results; and
refreshing the identified cache results in the local service cache.

15. The computer-implemented method of claim 14 wherein identifying cache results to be refreshed comprises:
identifying all results in the local service cache as cache results to be refreshed.

17. The computer-implemented method of claim 14 wherein identifying cache results to be refreshed comprises:
identifying cache results responsive to a set of most frequent calls as the cache results to be refreshed.

18. The computer-implemented method of claim 14 wherein identifying cache results to be refreshed comprises:
identifying cache results as the cache results to be refreshed based on a computing overhead used by the remote service system in servicing corresponding calls for the cache results.

19. A computer readable storage medium that stores computer executable instructions which, when executed by a computer, cause the computer to perform a method, comprising:
receiving, at a local service system that is local to a multi-tenant computing system, a call from a calling system to a remote service system;
determining whether a matching result, that matches the call, is stored in a local service cache;
if so, accessing a set of refresh rules and a freshness parameter provided in the call to determine whether the matching result is to be refreshed and, if the matching result is not to be refreshed, then returning the matching result to the calling system from the local service cache in response to the call; and
if the matching result is to be refreshed based on the refresh rules or freshness parameter or if a matching result is not stored in the local service cache, then sending the call to the remote service system, receiving fresh results from the remote service system, and storing the fresh results in the local service cache.

20. The computer readable storage medium of claim 19 wherein the fresh result is over-inclusive of results responsive to the call, and further comprising:
parsing the fresh result to identify the results responsive to the call;
breaking the results responsive to the call into pages;
returning to the calling system the results responsive to the call; and
storing the results responsive to the call in the local service cache with a call indicator identifying the call the results are responsive to.
